(19) United States
(12) Patent Application Publication
(10) Pub. No.: US 2025/0147734 A1
(43) Pub. Date: May 8, 2025

(54) AUTOMATED OPERATION FOR SERVER LOG ACQUISITION

(71) Applicant: RAKUTEN MOBILE, INC., Tokyo (JP)

(72) Inventor: Ryuki OSHIRO, Tokyo (JP)

(73) Assignee: RAKUTEN MOBILE, INC., Tokyo (JP)

(21) Appl. No.: 17/927,146

(22) PCT Filed: Jun. 28, 2022
(86) PCT No.: PCT/JP2022/025743

§ 371 Date: Jan. 16, 2025

(51) Int. Cl. G06F 8/30

(52) U.S. Cl. CPC G06F 8/30

(57) ABSTRACT

A network management apparatus performs a first acquisition process, a generation process, and a second acquisition process. The first acquisition process is processing that acquires server information capable of identifying a target physical server for acquiring a log among physical servers that constitute a virtualized environment of a network. The generation process is processing that generates, based on the server information, a program that corresponds to the target physical server for acquiring the log and acquires the log of the target physical server. The second acquisition process is processing that executes the program and acquires the log of the target physical server for acquiring the log.

### TECHNICAL FIELD

The present disclosure relates to automated operation for acquiring logs of servers.

### BACKGROUND ART

Conventionally, a certain system has been known that collects information from multiple network devices deployed in remote locations via the Internet, monitors the network devices by a management server, and uses the collected information to maintain the network devices.

Patent literature 1 discloses a system including network devices and a management server that manages network devices. The management server implements the device management by collecting device information and device operational information from the network devices via the Internet. The above network devices include, for example, image processing devices such as printers, copiers, network cameras, digital medical devices, and the like.

### LISTING OF REFERENCES

### Patent Literature

PATENT LITERATURE 1: Laid-open Publication of Japanese Patent Application No. 2017-54397 A

### SUMMARY OF THE INVENTION

### Problems to be Solved by the Invention

With a background of improved performance of general-purpose servers and enhanced network infrastructures, cloud computing (hereinafter simply referred to as “cloud”), which on demand uses computing resources that are virtualized on physical resources such as servers, has become widely prevailing. In addition, the Network Function Virtualization (NFV), which virtualizes network functions and provides the virtualized network functions on the cloud, has been well known. The NFV is a technology that uses virtualization and cloud technologies to separate the hardware and software of various network services, which used to run on dedicated hardware, and to run the software on a virtualized infrastructure. It is expected to improve the sophistication of operations and reduce costs by use of those virtualization technologies.

Recent telecom networks are large-scale networks constructed on a virtualized infrastructure. For network construction, maintenance, and operation, necessary log information is acquired for a large number of physical servers deployed at respective data centers (i.e., accommodating stations), and the status of each of physical servers is individually monitored and managed.

A virtualized network using general-purpose servers contains a greater number of devices from different vendors than a conventional network using dedicated hardware. Conventionally, operators (e.g., administrators) have performed operations defined for each of servers (e.g., for each of vendors) to acquire log information, and an operation for acquiring logs has been quite labor intensive.

Therefore, the present disclosure addresses problems to acquire logs of physical servers that constitute a virtualized network more efficiently.

### Solution to Problems

In order to solve the above mentioned problems, according to one aspect of the present disclosure, there is provided a network management apparatus, comprising one or more processors, at least one of the one or more processors being configured to perform a first acquisition process, a generation process, and a second acquisition process. The first acquisition process is processing that acquires server information capable of identifying a target physical server for acquiring a log among physical servers that constitute a virtualized environment of a network. The generation process is processing that generates, based on the server information, a program that corresponds to the target physical server for acquiring the log and acquires the log of the target physical server. The second acquisition process is processing that executes the program and acquires the log of the target physical server for acquiring the log.

In order to solve the above mentioned problems, according to another aspect of the present disclosure, there is provided a network management method, comprising: acquiring server information capable of identifying a target physical server for acquiring a log among physical servers that constitute a virtualized environment of a network; generating, based on the server information, a program that corresponds to the target physical server for acquiring the log and acquires the log of the target physical server; and executing the program and acquiring the log of the target physical server for acquiring the log.

In order to solve the above mentioned problems, according to yet another aspect of the present disclosure, there is provided a network management system, comprising one or more processors, at least one of the one or more processors being configured to perform a first acquisition process, a generation process, and a second acquisition process. The first acquisition process is processing that acquires server information capable of identifying a target physical server for acquiring a log among physical servers that constitute a virtualized environment of a network. The generation process is processing that generates, based on the server information, a program that corresponds to the target physical server for acquiring the log and acquires the log of the target physical server. The second acquisition process is processing that executes the program and acquires the log of the target physical server for acquiring the log.

### Advantageious Effect of the Invention

According to one aspect of the present disclosure, it makes it possible to acquire logs of physical servers that constitute a virtualized network more efficiently.

### BRIEF DESCRIPTION OF DRAWINGS

FIG. 1 is a conceptual diagram illustrating an exemplary network configuration of a mobile network including a network management apparatus according to the present embodiment.

FIG. 2 is a block diagram illustrating an exemplary internal configuration of a network management system.

FIG. 3 is a block diagram illustrating an exemplary functional configuration of a log acquisition section.

FIG. 4 is a sequence diagram illustrating an exemplary operation for acquiring logs of servers.

FIG. 5 is a flowchart illustrating an exemplary processing procedure of script generation processing.

FIG. 6 is a conceptual diagram illustrating an exemplary outline of the script generation processing.

FIG. 7 is a schematic diagram illustrating an example of extracting logs for analysis.

FIG. 8 is a block diagram illustrating an exemplary hardware configuration of the network management apparatus.

### DESCRIPTION OF EMBODIMENTS

Hereinafter, embodiments of the present invention will be described in detail with reference to the accompanying drawings. Among the constituent elements disclosed herein, those having the same function are denoted by the same reference numerals, and a description thereof is omitted. It should be noted that the embodiments disclosed herein are illustrative examples as means for implementing the present invention, and should be appropriately modified or changed depending on a configuration and various conditions of an apparatus to which the present invention is applied, and the present invention is not limited to the following embodiments. Furthermore, it should be noted that all of the combinations of features described in the following embodiments are not necessarily essential to the solution of the present invention.

Hereinafter, a non-limiting example will be described in which a network management apparatus according to the present embodiment has a log acquisition function that acquires logs of physical servers in a mobile network constructed on a virtualized infrastructure.

More specifically, the network management apparatus according to the present embodiment acquires server information that is capable of identifying a target physical server for acquiring a log from among the physical servers that constitute a virtualized environment of the network. Based on the acquired server information, the network management apparatus generates a program that corresponds to the target physical server for acquire the log and is used for acquiring the log of the target physical server concerned. The network management apparatus then executes the generated program to acquire the log of the target physical server for acquiring the log.

Furthermore, the network management apparatus according to the present embodiment may extract information necessary for analyzing hardware from the acquired log of the physical server and output the extracted information as a log for analysis.

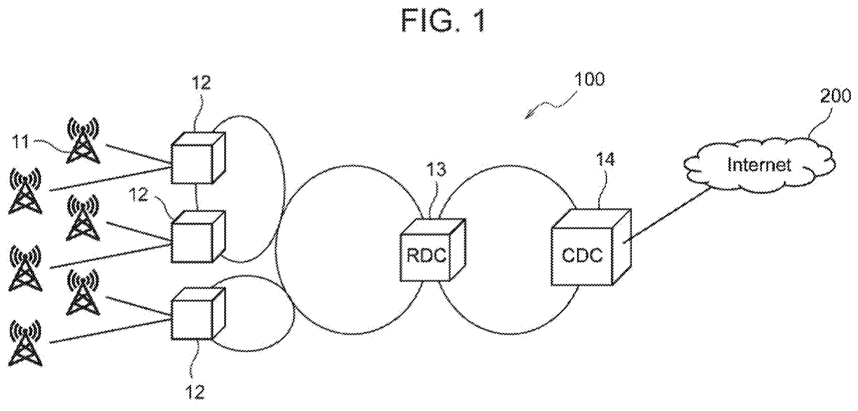

FIG. 1 is a conceptual diagram illustrating an exemplary network configuration of a mobile network 100 including a network management apparatus according to the present embodiment.

In the mobile network 100 shown in FIG. 1, a terminal capable of mobile communication such as a smartphone and the Radio Access Network (RAN) communicate with each other wirelessly, and the transmitted information is relayed through the backhaul network (i.e., Mobile Backhaul: MBH) to the core network for processing. This allows the mobile communication terminal to connect to the Internet 200 or connect to another company's network to make voice calls, or the like.

More specifically, the mobile network 100 includes base stations 11 and a plurality of accommodating stations 12 to 14. In FIG .1, the accommodating station 12 is an edge data center, the accommodating station 13 is a Regional Data Center (RDC), and the accommodating station 14 is a Central Data Center (CDC). The backhaul network is constituted between the edge data center 12 and the central data center 14.

The mobile network 100 according to the present embodiment may be a virtualized network constructed on a virtualization infrastructure. The mobile network 100 realizes everything from the switching equipment of the backbone network to the radio access functions of the base stations by software on general-purpose servers.

The base station 11 is equipped with an antenna, a switchboard, a battery, and the like.

The edge data center 12 is located near the base stations 11 and is connected to a plurality of base stations 11 via fiber-optic cables, or the like. The edge data center 12 realizes the RAN-related radio access functions.

The regional data center 13 is connected to a plurality of edge data centers 12. The regional data center 13 realizes various applications by software, for the firewall/NAT (Network Address Translation), the CDN (Content Distribution Network), and edge computing.

The central data center 14 is connected to a plurality of regional data centers 13. The central data center 14 realizes core functions such as the EPC (Evolved Packet Core), the IMS (IP Multimedia Subsystem), or the like.

It should be noted that the number of respective data centers (i.e., accommodating stations), that is, the edge data center 12, the regional data center 13, and the central data center 14, is not limited to the number shown in FIG. 1. For example, although only one regional data center 13 and one central data center 14 are shown in FIG. 1, there may be a plurality of regional data centers 13 and central data centers 14, respectively.

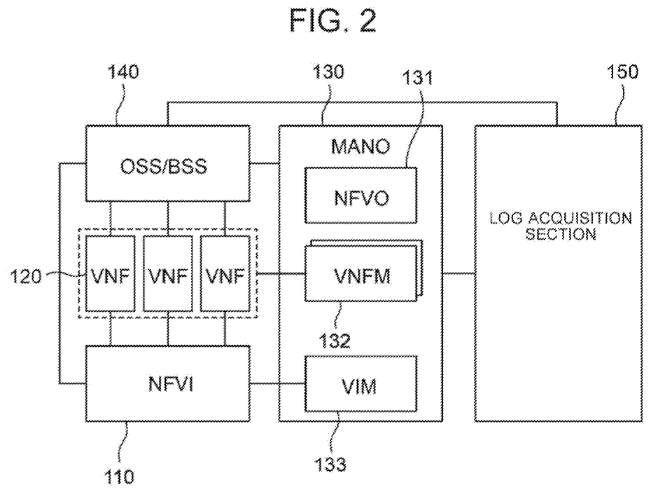

FIG. 2 is a block diagram illustrating an exemplary internal configuration of a network management system that constitutes the mobile network 100.

Each of constituent elements shown in FIG. 2 has a reference point. The lines connecting the constituent components shown in FIG. 2 indicate that connected constituent elements can send and receive information with each other.

The NFVI (NFV Infrastructure) 110 is a network function virtualization infrastructure, and includes physical resources, a virtualization layer, and virtualized resources. The physical resources include hardware resources such as computing resources, storage resources, and transmission resources. The virtualization layer is a virtualizing layer such as a hypervisor for virtualizing the physical resources and providing the virtualized physical resources to the VNF (Virtual Network Function) 120. The virtualized resources are the virtualized infrastructure resources provided to the VNF 120.

In other words, the NFVI 110 is an infrastructure that enables flexible handling of hardware resources of physical servers (hereinafter also simply referred to as “servers”), such as computing, storage, and network functions, and renders these hardware resources into virtualized hardware resources such as virtualized computing, virtualized storage, and virtualized network, which are virtualized by the virtualization layer such as the hypervisor.

A plurality of servers that constitute the NFVI 110 are grouped together and deployed in each of the data centers (i.e., accommodating stations) 12 to 14. The number, the placement positions, wiring, and the like, of the servers to be deployed in each of the data centers 12 to 14 are predetermined depending on the type of data center (i.e., accommodating station type). In each of the data centers 12 to 14, the deployed servers are connected by an internal network and are capable of sending and receiving information from each other. In addition, the data centers are connected to each other by a network, and the servers in different data centers are capable of sending and receiving information from each other via the network.

The VNF 120 corresponds to applications running on virtual machines (VMs) on the servers and implements the network functions by software. Although not specifically shown, each VNF 120 may be provided with a management function called an EM (Element Manager).

The NFVI 110 and the VNF 120 in FIG. 2 constitute the virtualized environment. In other words, the virtualized environment is constituted with three layers, in the bottom-up order namely: the hardware, the virtualization layer, and virtual machines.

The MANO (Management and Orchestration) 130 has management and orchestration functions for the virtualized environment. The MANO 130 includes the NFVO (NFV-Orchestrator) 131, the VNFM (VNF-Manager) 132, and the VIM (Virtualized Infrastructure Manager) 133.

The NFVO 131 orchestrates the NFVI resources, manages the lifecycle of network services, and provides integrated operational management of the entire system. The NFVO 131 is capable of performing processing in response to instructions from the OSS/BSS (Operation Support System/Business Support System) 140, which will be described below.

The VNFM 132 manages the lifecycle of each of the VNFs 120. It should be noted that the VNFM 132 may be arranged in the MANO 130 as a dedicated VNFM corresponding to each of the VNFs 120. Alternatively, a single VNFM 132 may manage the lifecycle of two or more VNFs 120. In this case, the VNFM 132 may be a general-purpose VNFM that supports VNFs 120 provided by different vendors.

The VIM 133 performs operational management of the resources used by the VNFs 120.

The OSS/BSS 140 is an integrated management system for the mobile network 100.

Here, the OSS is a system (i.e., equipment, software, mechanism, and the like) necessary for constructing and operating the desired services, and the BSS is an information system (i.e., equipment, software, mechanism, and the like) used for billing, invoicing, and customer services.

The log acquisition section 150 realizes the log acquisition function that acquires logs of servers, which constitutes a part of the NFVI 110. The log acquisition section 150 serves as the network management apparatus according to the present embodiment.

In the mobile network 100, during respective phases of construction, maintenance, and operation of the network, logs of the servers that constitute the virtualized environment of the network are being acquired, and the statuses of the servers are being individually monitored and managed.

For example, when a failure occurs in a server, it is required to acquire a log of the failed server in order to analyze the cause of the failure. Also, for example, when newly constructing a data center (i.e., accommodation station), a server is deployed in the data center, and the operating system (OS), and the like, is installed on the server after confirming the normality of hardware of the server concerned. In this case, it is also required to acquire a log of the server to confirm the normality thereof.

According to the present embodiment, a target server for acquiring a log may include at least one of a server in which a failure is occurring and a bare metal server of which normality needs to be confirmed.

It should be noted that the target server for acquiring the log is not limited to the above, but may be any server that constitutes the virtualized environment of the mobile network 100.

Conventionally, operators (e.g., administrators) have acquired logs of servers by operating a prescribed management tool. More specifically, the operators have manually input a GUI (Graphical User Interface), a RESTful API, an IPMI (Intelligent Platform Management Interface), or the like, through the management tool to acquire the logs required for monitoring and operating servers.

However, a virtualized network using general-purpose servers contains a greater number of devices from different vendors than a conventional network using dedicated hardware. The above management tool is defined differently for each of vendors, and each of management tools has a different operation method and commands to be entered from another vendor's management tool.

For this reason, operators had to learn the operations by referring to various procedure manuals provided by respective vendors, which placed a heavy burden on the operators to become proficient in the operations for acquiring logs of servers. Furthermore, differences in the degree of proficiency of operators due to differences in experience and other factors result in differences in the promptness and accuracy of the operations for acquiring logs. In addition, differences in operations among various vendors may confuse operators, thereby lead to human errors.

Therefore, according to the present embodiment, the log acquisition section 150 automatically generates a program to acquire a log for each of target servers for acquiring a log, and executes the generated program to acquire the log. This allows operators to acquire logs of servers in a unified workflow that is independent or nearly independent from vendors, or the like. As a result, it makes it possible to reduce the burden of operators and the occurrence of errors.

In addition, a log acquired by executing commands defined by each of vendors is in compliance with the standards of each of vendors and may include a log that is not needed for analysis. Therefore, when an operator performing the analysis is not familiar with the analytical work, errors in the analysis results may be incurred. Such erroneous analysis results may lead to inefficient or inappropriate operations, which may adversely affect services.

Therefore, according to the present embodiment, the log acquisition section 150 may extract information necessary for analyzing hardware from the log acquired from the server and output the extracted information as a log for analysis. This allows the server's log for analysis to be acquired in a unified format that is independent or nearly independent from vendors or the like. As a result, it makes it possible to suppress errors in analysis results.

It should be noted that the log acquisition section 150 is not limited to the case in which the log acquisition section 150 is an external function of the OSS/BSS 140 or the MANO 130, as shown in FIG. 2. The log acquisition section 150 may be provided inside the OSS/BSS 140 or the MANO 130. In this case, the log acquisition function of the log acquisition section 150 becomes a part of the functions of the OSS/BSS 140 or the MANO 130.

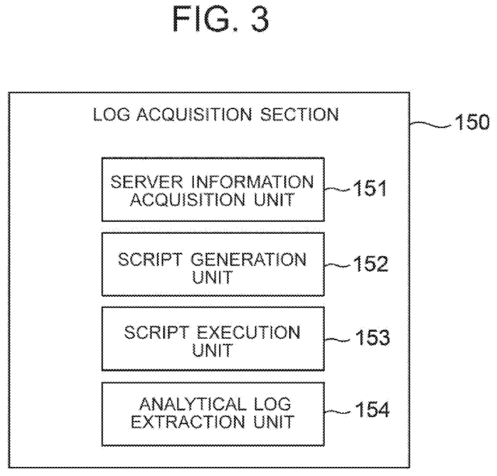

FIG. 3 is a functional block diagram illustrating an exemplary functional configuration of the log acquisition section 150.

As shown in this FIG. 3, the log acquisition section 150 includes a server information acquisition unit 151, a script generation unit 152, a script execution unit 153, and an analytical log extraction unit 154.

The server information acquisition unit 151 acquires server information that is capable of identifying a target physical server for acquiring a log. Here, the server information acquired by the server information acquisition unit 151 includes information that is capable of identifying each individual server, such as a server ID, an IP address of Baseboard Management Controller (BMC) (BMC_IP), and the like. The server information acquired by the server information acquisition unit 151 may further include at least one of a vendor name, a vendor ID, a model number, and a firmware version of a server.

The server information acquisition unit 151 is able to acquire the server information, for example, by acquiring an input file that directly describes the above server information.

It should be noted that the method of acquiring the server information is not limited to the method in the file format described above, but may be, for example, by inputting commands. In this case, the server information acquisition unit 151 may acquire the server information by accepting commands describing the server information, which is input by an operator.

The server information acquisition unit 151 may alternatively access a predetermined node to acquire the above server information. The server information acquisition unit 151 may, for example, access a target server for acquiring a log by using the BMC_IP input by an operator to acquire the firmware version of the target server.

The script generation unit 152 generates a script to acquire the log of the target server for acquiring the log based on the server information acquired by the server information acquisition unit 151. Here, the script is a script that corresponds to the target server for acquiring the log. For example, the script generation unit 152 may generate different scripts by server vendor, and even by server model number or server firmware.

Although the present embodiment will describe an exemplary case of generating a script for acquiring a log, the present embodiment is not limited thereto, and it may suffice to generate any program that executes one or a series of commands for acquiring a log.

The script execution unit 153 executes the script generated by the script generation unit 152 to acquire a log of the target server for acquiring the log.

The analytical log extraction unit 154 extracts information necessary for analyzing hardware of the server from the log acquired by executing the script by the script execution unit 153, and outputs the extracted information as a log for analysis (i.e., analytical log).

It should be noted that the configuration of the functional blocks of the log acquisition section 150 shown in FIG. 3 is no more than an example, and multiple functional blocks may constitute one functional block, or any of the functional blocks may be divided into blocks that perform multiple functions, respectively.

In addition, the multiple functions of the log acquisition section 150 may be divided into external functions of the OSS/BSS 140 or the MANO 130, internal functions of the OSS/BSS 140, and internal functions of the MANO 130, respectively.

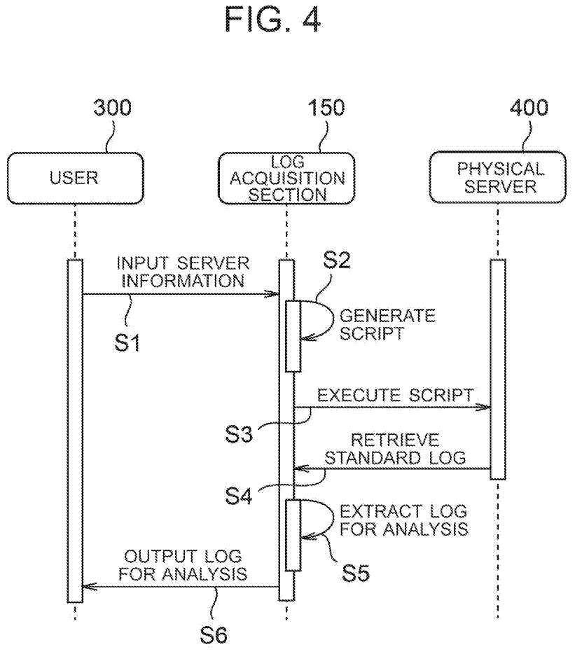

FIG. 4 is a sequence diagram illustrating an exemplary operation for acquitting logs of servers.

For example, when a server fails, an alert is notified from the NFVI 110 or VNF 120 in relation to the failure that has occurred. Here, the above alert includes an error, a warning, and a notification. In this case, a primary analysis is first performed to analyze the notified alert and identify the server (i.e., suspected node) where the failure is assumed to have occurred. This primary analysis may be performed, for example, using a prescribed analysis tool.

The user (e.g., operator) 300 selects the server identified by the primary analysis as a target server for acquiring a log, and in step S1 of FIG. 4, inputs the server information of the target server. Alternatively, the user 300 may input the server information to the OSS 140, and the OSS 140 may forward the server information received from the user 300 to the log acquisition section 150.

In step S2, based on the server information input in step S1, the log acquisition section 150 generates a script to acquire (retrieve) a log of the target server for acquiring the log.

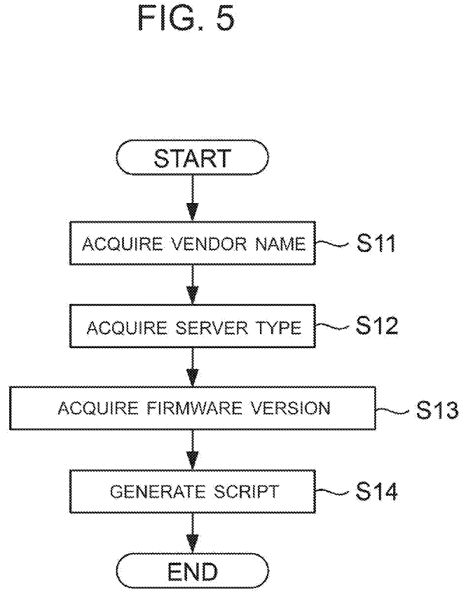

FIG. 5 is a flowchart illustrating an exemplary processing procedure of script generation processing performed by the log acquisition section 150.

First, in step S11, the script generation unit 152 of the log acquisition section 150 acquires a vendor name of a target server for acquiring a log from the server information. The script generation unit 152 may also acquire a vendor ID of the target server.

In step S12, the script generation unit 152 acquires a model number (e.g., server type) of the target server for acquiring logs from the server information.

In step S13, the script generation unit 152 acquires a firmware version of the target server for acquiring the log from the server information.

Subsequently, in step S14, the script generation unit 152 generates a script to acquire a log of the target server for acquiring the log based on the information acquired in steps S11 to S13.

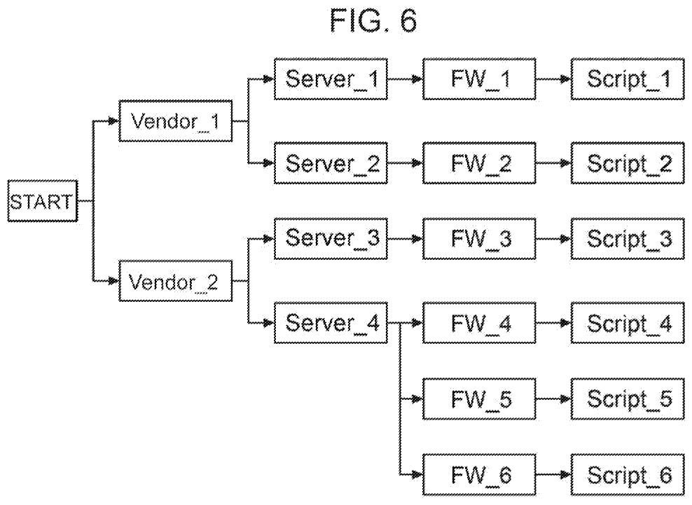

FIG. 6 is a conceptual diagram illustrating an exemplary outline of the script generation processing.

Commands for acquiring logs of servers vary from vendor to vendor. The commands may also vary by server type or by firmware version, even when the vendor is the same. Therefore, as shown in FIG. 6, the script generation unit 152 generates a script for each of vendors, each of server types, and even each of firmware versions.

For example, assuming that the vendor name of a target server for acquiring a log is “Vender_1”, the server type is “Server_1”, and the firmware version is “FW_1”, the script generation unit 152 generates the script “Script_1”.

Returning back to FIG. 4, in step S3, the log acquisition section 150 executes the script generated in step S2. The command executed at this time is a command that is defined for each of vendors of a target server for acquiring a log (physical server) 400 and is generated according to the server type or the firmware version. Thus, the log acquisition section 150 automatically generates and executes commands according to the vendor, server type, and firmware version.

Subsequently, in step S4, the log acquisition section 150 acquires a log from the target server for acquiring the log (physical server) 400. The log acquired at this time is a standard log that is in compliance with the standard of each of vendors.

When the log acquisition section 150 acquires the standard log from the server 400, in step S5, the log acquisition section 150 performs the analytical log extraction processing that extracts only the log for analysis from the standard log in step S5.

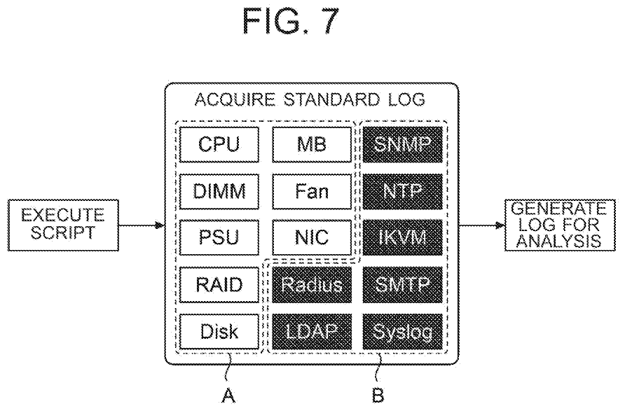

For example, as shown in FIG. 7, the standard log acquired by executing the script may also include, in addition to the information A required for analyzing hardware, other information B that is not required for analyzing hardware, such as information on the SNMP (Simple Network Management Protocol), the NTP (Network Time Protocol), and the like.

Therefore, in step S5 in FIG. 4, the log acquisition section 150 extracts, as the log for analysis, only the information A necessary for analyzing hardware from the standard log.

The above log for analysis may include, for example, as shown as the information A in FIG. 7, information on at least one of a CPU (Central Processing Unit), a DIMM (Dual Inline Memory Module), a PSU (Power Supply Unit), a RAID (Redundant Arrays of Inexpensive Disks), an MB (motherboard), a fan and a NIC (Network Interface Card). By outputting those kinds of information as the log for analysis, an operator is able to appropriately assess the status of the server concerned.

Yet subsequently, in step S6, the log acquisition section 150 sends the log for analysis extracted in step S5 to the user 400. The log for analysis may be output in a predefined format (e.g., text format).

It should be noted that the output destination of the log for analysis is not limited to the user 400. For example, the log for analysis may be output to a tool that performs secondary analysis of failures, or the like.

As described above, the log acquisition section 150, which serves as the network management apparatus according to the present embodiment, acquires the server information that is capable of identifying a target server for acquiring a log from among servers (i.e., physical servers) that constitute the virtualized environment of the network. In addition, based on the above server information, the log acquisition section 150 generates a script (i.e., program) that corresponds to the target server for acquiring the log and is used to acquire the log of the target server. Subsequently, the log acquisition section 150 executes the generated script to acquire a log of the target server for acquiring the log.

Accordingly, the log acquisition section 150 according to the present embodiment is able to automatically generate and execute scripts for acquiring logs. As a result, it makes it possible to reduce the workload of operators and suppress errors due to manual operations from occurring.

In addition, the log acquisition section 150 is able to generate scripts for acquiring logs corresponding to the target servers for acquiring logs. Accordingly, even when the commands for acquiring logs differ from server to server, it makes it possible to acquire the logs of the target servers for acquiring logs appropriately.

In a virtualized network constituted with devices from multiple vendors, for example, different commands defined by each of vendors are executed to acquire logs of servers. Those commands for acquiring logs may vary depending on the model number, the firmware version, and the like, of servers. For this reason, when operations for acquiring logs are manually performed, an operator is required to learn different management tools and commands, which vary by vendor, or the like, thereby incurring a heavy burden. In addition, the above mentioned operations, which are difficult to acquire proficiency, are likely to be operations depending on a particular person. Furthermore, even when an operator is proficient in the operation, human error is likely to occur in the case of manual operations.

According to the present embodiment, as described above, it makes it possible to automate operations for acquiring logs of servers, thereby improving the efficiency of the operations. In addition, it makes it possible to suppress incorrect operations by operators, thereby avoiding adverse effects on the commercial environment.

Furthermore, the log acquisition section 150 is also able to acquire, as the server information, at least one of the vendor name, the vendor ID, the model number, and the firmware version of each of servers.

As a result, even when commands for acquiring logs vary from vendor to vendor, and even by server type and firmware version, the log acquisition section 150 is able to appropriately generate scripts for acquiring logs so as to retrieve logs of servers appropriately.

Yet furthermore, the log acquisition section 150 may acquire the server information by acquiring an input file that describes the server information of a target server for acquiring a log.

In this case, it makes it possible to acquire logs with vendor-independent or almost vendor-independent input. Therefore, it makes it possible to avoid the occurrence of problems due to input errors by operators.

Here, the target server for acquiring the log may be, for example, a server where a failure has occurred. By acquiring the logs of the server where the failure has occurred, an operator is able to perform the analysis task to identify the cause of the failure, thereby advancing the restoration operation appropriately.

The target server for acquiring the log may be, for example, a bare metal server with no OS or other software being installed. By acquiring the logs of the bare metal servers, an operator is able to confirm the normality of the bare metal server and have the bare metal server provisioned normally.

In a virtualized network constituted with servers from multiple vendors, the logs acquired from the servers by executing commands each defined by each vendor are in compliance with the standards defined by each of vendors. In other words, the information included in the acquired logs differs depending on the vendor, and the like, as well as the position in a log where the information to be confirmed is described. Therefore, operators who are not proficient in the operations are likely to take considerable time to analyze the logs, or even may not be able to assess the logs appropriately.

In contrast, the log acquisition section 150 is able to extract information necessary for analyzing hardware from the acquired logs and output the extracted information as a log for analysis. Thus, it makes it possible to obtain vendor-independent or almost vendor-independent output. As a result, operators are able to analyze logs expeditiously and appropriately.

Telecom networks require high reliability and high availability, so when a failure occurs in the telecom network, promptness in recovery is required. For example, when a server in a remote location fails, it is required to analyze a log of the failed server to find the cause of the failure and derive the optimal solution that shows the path to recovery as soon as possible.

According to the present embodiment, as the server's log for analysis can be output expeditiously and appropriately, operators are able to analyze the logs appropriately regardless of differences in proficiency so as to perform the maintenance operations. As a result, it makes it possible to avoid inefficient restoration operations caused by errors in log analysis results so as to reduce the time required for restoration (i.e., network failure time). In addition, it makes it possible to avoid an adverse impact on services caused by erroneous operations, and the like.

As described above, according to the present embodiment, it makes it possible to acquire logs of physical servers that constitute a virtualized network efficiently and appropriately. According to the present embodiment, it also makes it possible to manage and monitor the server statuses for agentless physical servers in remote locations.

The network management apparatus according to the present embodiment may be implemented in any of general-purpose servers that constitute the backhaul network, the core network, or the like, of the mobile network 100. Alternatively, the network management apparatus may be implemented in a dedicated server. The network management apparatus may also be implemented on a single or a plurality of computers.

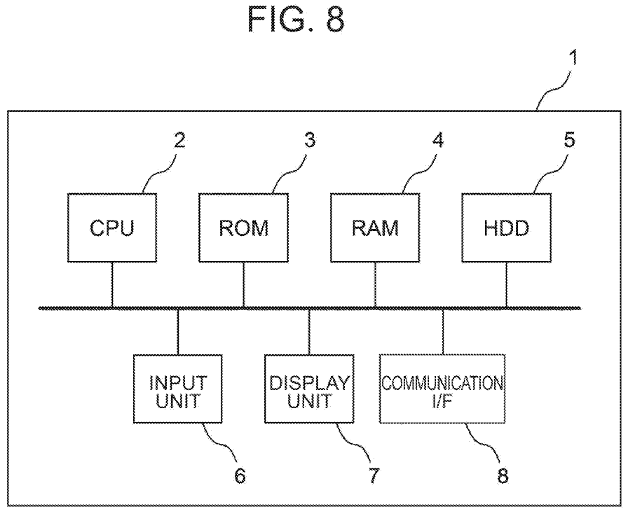

When the network management apparatus is implemented on a single computer, as shown in FIG. 8, the network management apparatus 1 may include a CPU 2, a ROM 3, a RAM 4, an HDD 5, an input unit (such as a keyboard, a pointing device) 6, a display unit (such as a monitor device) 7, a communication I/F 8, and the like. The network management apparatus 1 may further include an external memory.

The CPU (Central Processing Unit) 2 is constituted with one or more processors and controls entire operations of the network management apparatus 1 in a comprehensive manner. At least a part of functions of respective components of the log acquisition section 150 shown in FIG. 3 may be implemented by the CPU 2 running programs. It should be noted that those programs may be stored in a non-volatile memory such as the ROM (Read Only Memory) 3, the HDD (Hard Disk Drive) 5, or the like, or alternatively, may be stored in the external memory such as a removable storage medium (not shown).

However, at least a part of the functions of the respective components of the log acquisition section 150 shown in FIG. 3 may be operated by dedicated hardware. In this case, operation of the dedicated hardware is under the control of the CPU 2 described above.

For functions realized by hardware, for example, by using a prescribed compiler, for example, a dedicated circuit can be generated automatically on an FPGA from the programs to realize the functions of respective functional modules by using a predetermined compiler. Furthermore, a gate array circuit may be formed in the same way as the FPGA and realized as hardware, or alternatively, an ASIC (Application Specific Integrated Circuit) may be used.

Embodiments of the present disclosure may include a computer-readable storage medium that stores programs, and the programs may include instructions that, when being executed by the CPU 2 (e.g., at least one of the one or more processors) of the network management apparatus 1, causes the network management apparatus 1 to perform at least one of the methods described above.

Although exemplary embodiments have been described above, the embodiments described are merely illustrative and are not intended to limit the scope of the present invention. The apparatus and methods described herein may be embodied in other forms than those described above. In addition, without departing from the scope of the present invention, omissions, substitutions, and modifications may be made to the above embodiments as appropriate. Such omissions, substitutions, and modifications fall within the scope of the appended claims and equivalents thereof, and fall within the technical scope of the present invention.

The present disclosure includes the following embodiments.

[1] A network management apparatus, comprising one or more processors, at least one of the one or more processors being configured to perform: a first acquisition process for acquiring server information capable of identifying a target physical server for acquiring a log among physical servers that constitute a virtualized environment of a network; a generation process for generating, based on the server information, a program that corresponds to the target physical server for acquiring the log and acquires the log of the target physical server; and a second acquisition process for executing the program and acquiring the log of the target physical server for acquiring the log.

[2] The network management apparatus according to [1], wherein the first acquisition process acquires, as the server information, at least one of a vendor name, a vendor ID, a model number, and a firmware version of the target physical server.

[3] The network management apparatus according to [1] or [2], at least one of the one or more processors further being configured to perform: an output process for extracting information necessary for analyzing hardware from the log and outputting the extracted information as a log for analysis.

[4] The network management apparatus according to [3], wherein the log for analysis includes information on at least one of a CPU (Central Processing Unit), a DIMM (Dual Inline Memory Module), a PSU (Power Supply Unit), a RAID (Redundant Arrays of Inexpensive Disks), a disk, an MB (motherboard), a fan, and a NIC (Network Interface Card).

[5] The network management apparatus according to any one of [1] to [5], wherein the first acquisition process acquires the server information by acquiring an input file that describes the server information of the target physical server for acquiring the log.

[6] The network management apparatus according to any one of [1] to [5], wherein the target physical server for acquiring the log includes at least one of a physical server that has been failing and a bare metal server of which normality needs to be confirmed.

[7] A network management method, comprising: acquiring server information capable of identifying a target physical server for acquiring a log among physical servers that constitute a virtualized environment of a network; generating, based on the server information, a program that corresponds to the target physical server for acquiring the log and acquires the log of the target physical server; and executing the program and acquiring the log of the target physical server for acquiring the log.

[8] A network management system, comprising one or more processors, at least one of the one or more processors being configured to perform: a first acquisition process for acquiring server information capable of identifying a target physical server for acquiring a log among physical servers that constitute a virtualized environment of a network; a generation process for generating, based on the server information, a program that corresponds to the target physical server for acquiring the log and acquires the log of the target physical server; and a second acquisition process for executing the program and acquiring the log of the target physical server for acquiring the log.

### REFERENCE SIGNS LIST

11: Base Station; 12: Edge Data Center; 13: Regional Data Center; 14: Central Data Center; 100: Mobile Network; 110: NFVI; 120: VNF; 130: MANO; 131: NFVO; 132: VNFM; 133: VIM; 140: OSS/BSS; 150: Log Acquisition Section; 151: Server Information Acquisition Unit; 152: Script Generation Unit; 153: Script Execution Unit; 154: Analytical Log Extraction Unit

What is claimed is:

1. A network management apparatus, comprising one or more processors, at least one of the one or more processors being configured to perform:
a first acquisition process for acquiring server information capable of identifying a target physical server for acquiring a log among physical servers that constitute a virtualized environment of a network;
a generation process for generating, based on the server information, a program that corresponds to the target physical server for acquiring the log and acquires the log of the target physical server; and
a second acquisition process for executing the program and acquiring the log of the target physical server for acquiring the log.

2. The network management apparatus according to claim 1, wherein
the first acquisition process acquires, as the server information, at least one of a vendor name, a vendor ID, a model number, and a firmware version of the target physical server.

3. The network management apparatus according to claim 1, at least one of the one or more processors further being configured to perform:
an output process for extracting information necessary for analyzing hardware from the log and outputting the extracted information as a log for analysis.

4. The network management apparatus according to claim 3, wherein
the log for analysis includes information on at least one of a CPU (Central Processing Unit), a DIMM (Dual Inline Memory Module), a PSU (Power Supply Unit), a RAID (Redundant Arrays of Inexpensive Disks), a disk, an MB (motherboard), a fan, and a NIC (Network Interface Card).

5. The network management apparatus according to claim 1, wherein
the first acquisition process acquires the server information by acquiring an input file that describes the server information of the target physical server for acquiring the log.

6. The network management apparatus according to claim 1, wherein
the target physical server for acquiring the log includes at least one of a physical server that has been failing and a bare metal server of which normality needs to be confirmed.

7. A network management method, comprising:
acquiring server information capable of identifying a target physical server for acquiring a log among physical servers that constitute a virtualized environment of a network;
generating, based on the server information, a program that corresponds to the target physical server for acquiring the log and acquires the log of the target physical server; and
executing the program and acquiring the log of the target physical server for acquiring the log.

8. A network management system, comprising one or more processors, at least one of the one or more processors being configured to perform:
a first acquisition process for acquiring server information capable of identifying a target physical server for acquiring a log among physical servers that constitute a virtualized environment of a network;
a generation process for generating, based on the server information, a program that corresponds to the target physical server for acquiring the log and acquires the log of the target physical server; and
a second acquisition process for executing the program and acquiring the log of the target physical server for acquiring the log.
